(19) United States
(12) Patent Application Publication
(10) Pub. No.: US 2016/0322888 A1
(43) Pub. Date: Nov. 3, 2016

(54) Rotating Electric Machine

(71) Applicant: KOMATSU LTD., Minato-ku, Tokyo (JP)

(72) Inventors: Natsuki Watanabe, Hiratsuka-shi (JP); Teiichirou Chiba, Hiratsuka-shi (JP); Yukihiko Sugmioto, Hiratsuka-shi (JP)

(21) Appl. No.: 15/108,662

(22) PCT Filed: Feb. 17, 2015
(86) PCT No.: PCT/JP2015/054276

§ 371 Date: Jun. 28, 2016

(30) Foreign Application Priority Data
Feb. 18, 2014 (JP) 2014-028528

(51) Int. Cl. H02K 29/03; H02K 19/10; H02K 19/16; H02K 9/19

(52) U.S. Cl. CPC H02K 29/03; H02K 9/19; H02K 19/103; H02K 19/16; H02K 2201/03; H02K 2213/03

(57) ABSTRACT

A rotary electric machine includes: a ring-shaped stator; a rotor disposed to an inside of the stator in a rotatable manner; a plurality of stator teeth provided to the stator equally spaced with each other in a circumferential direction, the stator teeth projecting toward the rotor and each provided with a coil wound therearound; and a plurality of rotor teeth provided to the rotor equally spaced with each other in a circumferential direction, the rotor teeth projecting toward the stator. The rotor teeth each include a convex teeth body and extending portions extending from both sides of an end of the teeth body in the circumferential direction, and a constricted portion with a circumferential minimum width smaller than a circumferential width of an end of each of the stator teeth is provided to an intermediate portion in a projecting direction of each of the rotor teeth.

### TECHNICAL FIELD

The present invention relates to a rotary electric machine, more specifically to an improvement in a switched reluctance (abbreviated as “SR” hereinafter) motor and a power generator having the same structure.

### BACKGROUND ART

An SR motor designed to reduce vibrations and noises has been proposed (see, for instance, Patent Literature 1). Such an SR motor includes a rotor teeth having at an end thereof: a convex first portion; second portions provided to both sides of the first portion in a circumferential direction; extensions provided to both sides of the second portion in the circumferential direction; and a waist portion defined by an undercut extending from each of the extensions toward a base end of each of the rotor teeth. The extensions are rounded so as not to be discontinuous with the second portion. The extensions serve to enlarge the width of the end of the rotor teeth as compared with a width of an end of each of stator teeth. Further, the undercut defining the waist portion has a gently curved shape to keep the extensions and the base end of the rotor teeth from being discontinuous.

### CITATION LIST

### Patent Literature(s)

Patent Literature 1 JP-A-11-262225

### SUMMARY OF THE INVENTION

### Problem(s) to be Solved by the Invention

However, the extensions provided to the rotor teeth of the SR motor disclosed in Patent Literature 1 are rounded and are continuous with the base end of the rotor teeth through the waist portion in a form of the gently curved undercut. Accordingly, the capability of the magnetic flux through to pass through the rotor teeth varies greatly, so that a temporal variation in a radial force generated between the rotor teeth and the stator teeth during the rotation of the rotor becomes steep. Accordingly, a harmonic of the radial force is increased to make it difficult to restrict the vibrations and noises, thereby failing to sufficiently reduce the vibrations and noises.

Further, since a large variation occurs in the capability of the magnetic flux for passing through the rotor teeth and thus the generated radial force is increased, there is a limit on reduction in the vibrations and noises.

An object of the invention is to provide a rotary electric machine capable of reliably and sufficiently reducing a generation of vibrations and noises.

### Means for Solving the Problem(s)

A rotary electric machine according to an aspect of the invention includes: a ring-shaped stator; a rotor disposed to an inside of the stator in a rotatable manner; a plurality of stator teeth provided to the stator equally spaced with each other in a circumferential direction of the stator, the stator teeth projecting toward the rotor and each provided with a coil wound therearound; and a plurality of rotor teeth provided to the rotor equally spaced with each other in a circumferential direction of the rotor, the rotor teeth projecting toward the stator, in which the rotor teeth each comprise a convex teeth body and extending portions extending from both sides of an end of the teeth body in the circumferential direction of the rotor, and a constricted portion with a circumferential minimum width smaller than a circumferential width of an end of each of the stator teeth is provided to an intermediate portion in a projecting direction of each of the rotor teeth.

In the rotary electric machine according to the above aspect of the invention, it is preferable that an edge is formed at a circumferential peripheral edge of an end of each of the extending portions.

In the rotary electric machine according to the above aspect of the invention, it is preferable that a circumferential width of an end of each of the rotor teeth is more than 1.5 times as large as the circumferential minimum width of the constricted portion.

In the rotary electric machine according to the above aspect of the invention, it is preferable that the circumferential minimum width of the constricted portion is less than 0.75 times as large as the width of the end of each of the stator teeth.

In the rotary electric machine according to the above aspect of the invention, it is preferable that each of the rotor teeth comprises an arc face continuously extending over the end of the teeth body and the extending portion, and a gap defined between the arc face and an arc face defined at the end of each of the stator teeth is circumferentially constant.

A rotary electric machine according to another aspect of the invention includes: a ring-shaped stator; a rotor disposed to an inside of the stator in a rotatable manner; a plurality of stator teeth provided to the stator equally spaced with each other in a circumferential direction, the stator teeth projecting toward the rotor and each provided with a coil wound therearound; and a plurality of rotor teeth provided to the rotor equally spaced with each other in a circumferential direction, the rotor teeth projecting toward the stator, in which the rotor teeth each comprise a convex teeth body, extending portions extending from both sides of an end of the teeth body in the circumferential direction, and an arc face continuously extending over the end of the teeth body and the extending portions, a gap defined between the arc face and an arc face defined at the end of each of the stator teeth is circumferentially constant, an edge is formed at a circumferential peripheral edge of an end of each of the extending portions, a constricted portion with a circumferential minimum width is provided to an intermediate portion in a projecting direction of each of the rotor teeth, a circumferential width of an end of each of the rotor teeth is more than 1.5 times as large as the circumferential minimum width of the constricted portion, and the circumferential minimum width of the constricted portion is less than 0.75 times as large as the width of the end of each of the stator teeth.

According to the above aspects of the invention, since each of the rotor teeth is provided with the extending portion and the constricted portion whose width is narrower than the width of the stator teeth, a magnetic saturation occurs therein to inhibit the magnetic flux from the stator teeth from passing through an inside of each of the rotor teeth, so that the peak of the generated radial force can be restrained at a lower level. Accordingly, the magnetic flux passing from the stator teeth to the rotor teeth can be restricted at the position for each of the rotor teeth to be squarely opposed to the stator teeth, thereby sufficiently reducing the vibrations and noises.

### BRIEF DESCRIPTION OF DRAWING(S)

FIG. 1 is a side elevational view showing a construction machine installed with a rotary electric machine according to an exemplary embodiment of the invention.

FIG. 2 is a plan view showing a part of the construction machine.

FIG. 3 is an exploded perspective view showing the rotary electric machine.

FIG. 4 is a cross sectional view showing the rotary electric machine.

FIG. 5 is a front elevational view showing a rotor and a stator of the rotary electric machine.

FIG. 6 is an enlarged illustration of a relevant part of the rotor and the stator.

FIG. 7 is a graph showing an advantage of the exemplary embodiment.

FIG. 8 is another graph showing another advantage of the exemplary embodiment.

FIG. 9 illustrates a modification of the invention.

### DESCRIPTION OF EMBODIMENT(S)

Exemplary embodiment(s) of the invention will be described below with reference to the attached drawings.

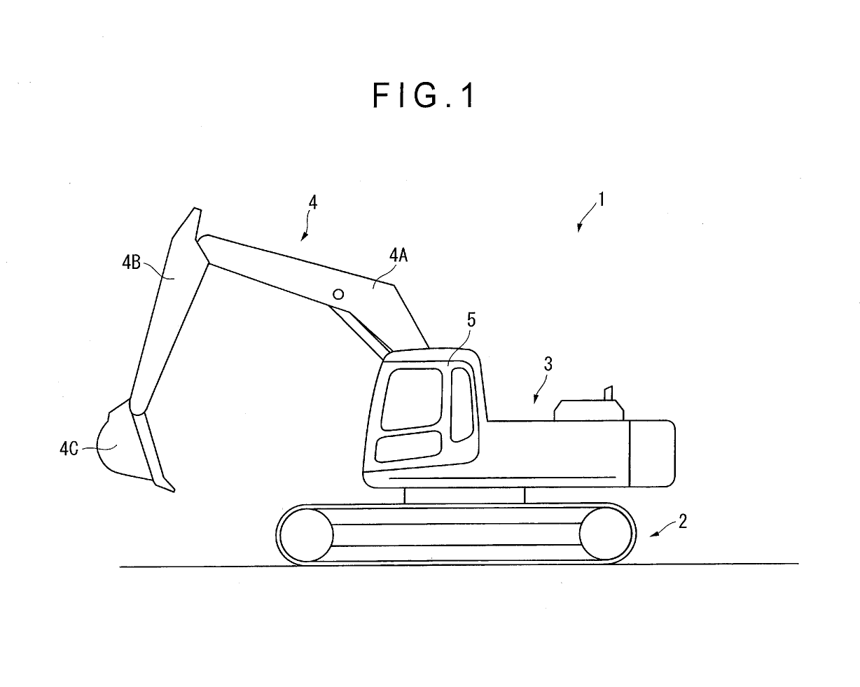

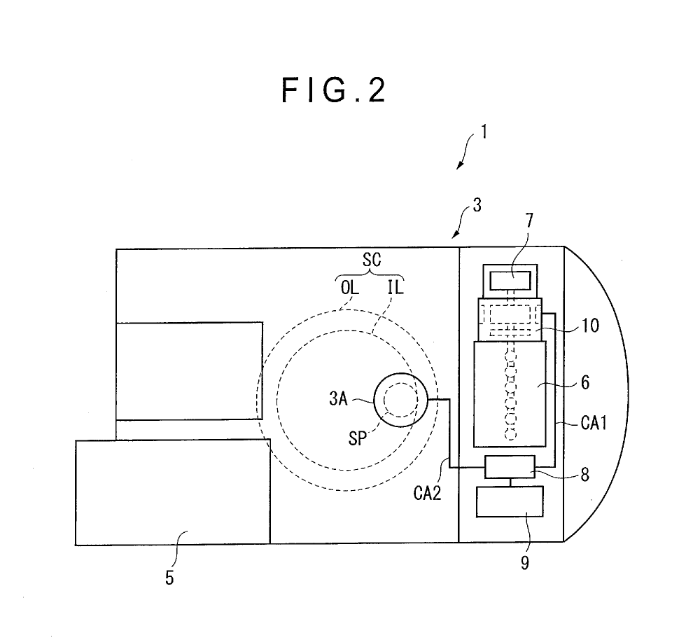

FIG. 1 is a side elevational view showing a hydraulic excavator 1 installed with a rotary electric machine in a form of a power generator motor 10 having teeth configured according to the exemplary embodiment. FIG. 2 is a plan view showing a part of the hydraulic excavator 1.

### [Overall Arrangement of Hydraulic Excavator]

The hydraulic excavator 1 is a so-called hybrid construction machine including an engine 6 and a power generator motor 10 driven by the engine 6 to generate electric power, the electric power being used in order to swing an upper structure 3 and to drive accessories of the hydraulic excavator 1.

The hydraulic excavator 1 includes an undercarriage 2, and the upper structure 3 swingably provided to the undercarriage 2. The upper structure 3 includes working equipment 4, a cab 5, the engine 6, a hydraulic pump 7, an inverter 8, a capacitor 9 and the power generator motor 10. The power generator motor 10 and the inverter 8 are electrically connected through a power cable CA1. The inverter 8 and the capacitor 9 are also electrically connected.

The upper structure 3 is driven by a rotary electric motor 3A actuated by electric energy from the power generator motor 10 and/or the capacitor 9. The rotary electric motor 3A and the inverter 8 are electrically connected through a power cable CA2. The rotary electric motor 3A generates electric power in accordance with a regenerative operation during deceleration of the upper structure 3. The electric energy thus obtained is accumulated in the capacitor 9 through the inverter 8.

An outer race OL of a swing circle SC is fixed to the upper structure 3. An inner race IL of the swing circle SC is fixed to the undercarriage 2. Thus configured swing circle SC connects the upper structure 3 and the undercarriage 2. An input/output shaft of the rotary electric motor 3A is connected with a swing pinion SP through a swing machinery including a deceleration mechanism. The swing pinion SP is meshed with inner teeth formed on the inner race IL of the swing circle SC.

The drive force of the rotary electric motor 3A is transmitted to the swing pinion SP through the swing machinery to swing the upper structure 3. In the exemplary embodiment, the rotary electric motor 3A is vertically situated (i.e. in a manner that, when the hybrid hydraulic excavator 1 is placed on a horizontal surface, the input/output shaft of the rotary electric motor 3A is oriented in a direction in which the gravity acts).

The working equipment 4 includes a boom 4A, an arm 4B and a bucket 4C. The boom 4A, the arm 4B and the bucket 4C are respectively driven by a hydraulic cylinder for the boom 4A, a hydraulic cylinder for the arm 4B and a hydraulic cylinder for the bucket 4C actuated by hydraulic oil pumped by the hydraulic pump 7 shown in FIG. 2 to perform various operations (e.g. excavation).

### [Arrangement of Power Generator Motor]

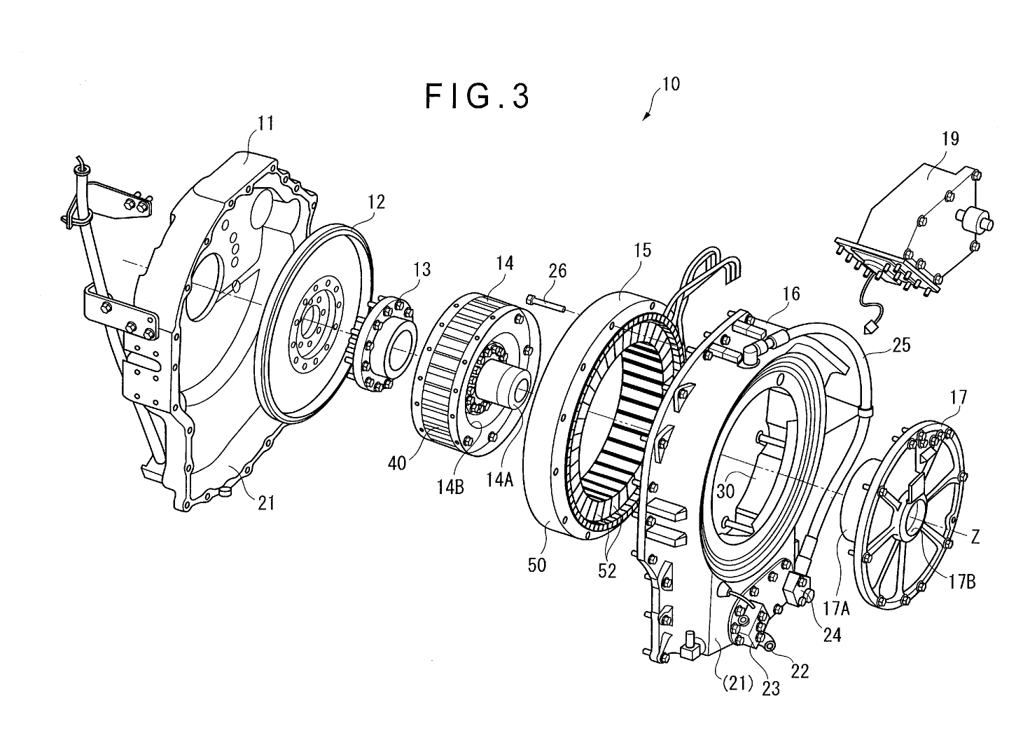

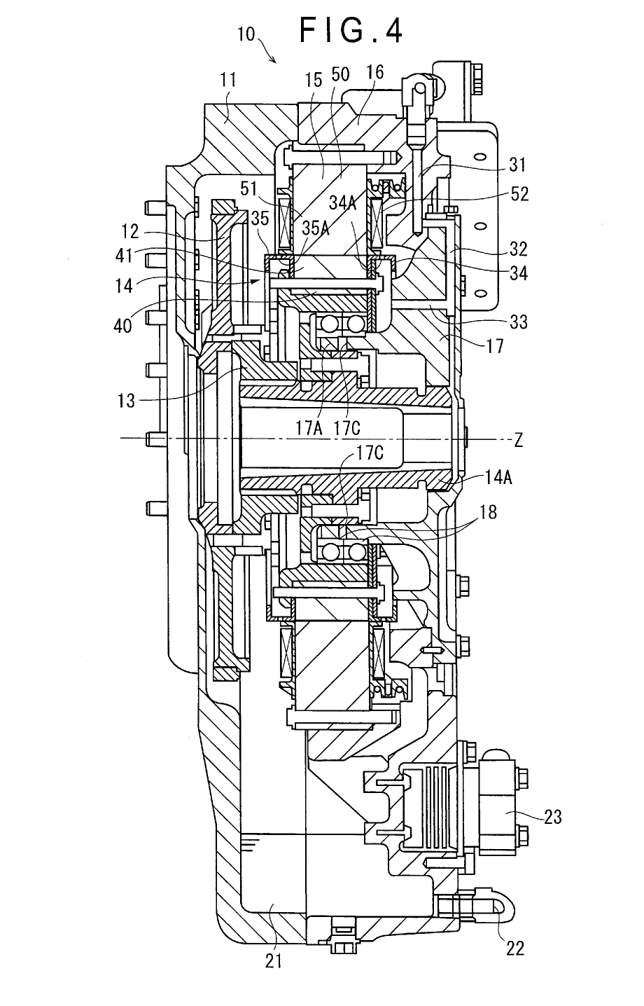

FIG. 3 is an exploded perspective view of the power generator motor 10 according to the exemplary embodiment. FIG. 4 is a cross section of the power generator motor 10. More specifically, FIG. 4 shows a cross section of the power generator motor 10 cut by a plane including a rotation center axis Z of a rotor 14 of the power generator motor 10 and being parallel to the rotation center axis Z.

The power generator motor 10 has a rotor shaft 14A directly or indirectly connected to an output shaft of the engine 6 and an input shaft of the hydraulic pump 7. The power generator motor 10 generates electric power using a rotary drive force of the output shaft of the engine 6. When, for instance, the speed of the engine 6 is to be increased, the power generator motor 10 is as necessary used as a motor using the electric energy accumulated in the capacitor 9 to assist the rotation of the engine 6. Further, when, for instance, the engine 6 is idling, the power generator motor 10 generates electric power using the rotary drive force of the engine 6 and the electric energy thus generated is accumulated in the capacitor 9.

The power generator motor 10 of the exemplary embodiment is configured as a three-phase SR motor and includes, for instance, a first housing 11 near the engine 6, a flywheel 12, a coupling 13, the rotor 14, a stator 15, a second housing 16 near the hydraulic pump 7 and a flange 17.

The first housing 11 is a component made of cast iron, which is connected with the second housing 16 to define therein a space for housing the rotor 14, the stator 15 and the like. An oil reservoir 21 for accumulating cooling oil for lubricating the rotor shaft 14A and the bearing 18 and for cooling a heat-generating member(s) (e.g. a coil 52) of the stator 15 is formed on the lower side of the housing space. The cooling structure of the stator 15 will be described later.

The flywheel 12 is fixed to the output shaft of the engine 6 in the housing space defined by the first and second housings 11, 16. The flywheel 12 is connected to the rotor 14 via the coupling 13 to be rotated inside the first and second housings 11, 16.

The coupling 13 is a substantially ring-shaped component bolted to the flywheel 12. The coupling 13 includes an internal spline that is formed on an inner circumferential surface thereof and mated with an external spline formed on an outer circumferential surface of a part of the rotor shaft 14A near the engine to define a spline coupling. Thus, the rotor 14 provided with the flywheel 12, the coupling 13 and the rotor shaft 14A are configured to be rotated together and driven by the engine 6.

The rotor 14 is disposed in a space near an inner circumferential surface of the stator 15 within the space defined by the first and second housings 11, 16. A support space 14B in which the rotor shaft 14A is bolted is defined at the center of the rotor 14. A cylindrical support 17A provided at the center of the flange 17 enters the support space 14B. The bearings 18, 18 are interposed between the inner circumferential surface defining the support space 14B and the outer circumferential surface of the support 17A, so that the rotor 14 is supported in a manner rotatable around the support 17A of the flange 17.

On the other hand, a part of the rotor shaft 14A of the rotor 14 near the hydraulic pump 7 is inserted into the support 17A of the flange 17. An internal spline is formed on the inner circumferential surface of the part of the rotor shaft 14A of the rotor 14 inserted into the support 17A. The internal spline and the external spline provided to the input shaft of the hydraulic pump 7 are spline-coupled. Thus, the hydraulic pump 7 is driven by the engine 6 through the rotor 14.

The stator 15 is disposed in the space defined by the first and second housings 11, 16. The stator 15 is bolted to the second housing 16 using a plurality of bolts 26 (only one of the bolts 26 is shown in FIG. 3) penetrating a rotor core 40 from a side thereof near the engine 6.

The second housing 16 is a component made of cast iron. The second housing 16 is provided to a side of the power generator motor 10 near the hydraulic pump 7 (right side in FIG. 4). The second housing 16 is bolted to the first housing 11. The second housing 16 and the bolted first housing 11 define the housing space for housing the flywheel 12, the coupling 13, the rotor 14 and the stator 15, and also an outer shell of the power generator motor 10.

An electronics box 19 including an interior space in communication with the housing space is attached to a shoulder of the second housing 16. A terminal for wiring a lead wire from the coil 52 is disposed in the interior space of the electronics box 19. The terminal is connected to a connector of the power cable CA1 (FIG. 2) fixed to the electronics box 19. In other words, the electric energy generated by the power generator motor 10 is transmitted through the electronics box 19 and the power cable CA1 to the inverter 8.

The flange 17 is a component for closing the housing space defined by the first and second housings 11, 16 from near the second housing 16. The flange 17 is bolted to the second housing 16 from the side thereof near the hydraulic pump 7. An insertion hole 17B coaxial with the support 17A is provided at the center of the flange 17. As described above, the input shaft of the hydraulic pump 7 inserted into the insertion hole 17B is spline-coupled with the rotor shaft 14A of the rotor 14.

### [Cooling Mechanism of Power Generator Motor]

As shown in FIG. 4, the second housing 16 is provided with a cooling medium introduction channel 31 for introducing a cooling medium (e.g. oil), the cooling medium introduction channel 31 extending toward the rotation center axis Z. A lower end of the cooling medium introduction channel 31 is open toward the flange 17 near a contact face of the second housing 16 with the flange 17. The flange 17 is provided with a vertical cooling medium communication channel 32 whose upper end is in communication with the lower end of the cooling medium introduction channel 31 and whose lower end is open to an end of the inner spline formed on the rotor shaft 14A. Further, the flange 17 is provided with a cooling medium branch channel 33 branched from an intermediate portion of the cooling medium communication channel 32 to extend in a horizontal direction to be opened at a part above the support 17A. The support 17A is provided with a plurality of circumferentially arranged radial communication holes 17C.

A part of the cooling medium supplied to the cooling medium introduction channel 31 of the second housing 16 drops down through the cooling medium communication channel 32 in the flange 17. A part of the dropped-down cooling medium flows through a gap between the flange 17 and the rotor shaft 14A into a space between the support 17A and the rotor shaft 14A. Another part of the cooling medium dropped down through the cooling medium communication channel 32 flows through the spline-coupled portion of the rotor shaft 14A and the input shaft of the hydraulic pump 7 (FIG. 2) into the interior space of the rotor shaft 14A.

The cooling medium flowed into the space between the support 17A and the rotor shaft 14A is moved to the inner surface of the support 17A by virtue of a centrifugal force caused when the rotor 14 is rotated, and is supplied to the bearing 18 through the communication holes 17C of the support 17A to cool and lubricate the bearing 18. The cooling medium having cooled the bearing 18 is moved further outward by the centrifugal force and the most of the cooling medium reaches a first blade 34 of a J-shaped cross section provided to the outer circumferential surface of the rotor 14. The cooling medium having reached the first blade 34 is discharged through a discharge hole 34A provided in the first blade 34 by virtue of the centrifugal force and is supplied to a gap between a coil end of the coil 52 and the second housing 16, thereby efficiently cooling the coil end of the coil 52 facing the second housing 16.

In contrast, the cooling medium entering the interior space of the rotor shaft 14A flows out of the spline-coupled portion of the rotor shaft 14A and the output shaft of the engine 6 (FIG. 2), and, subsequently, flows out to the outer circumferential surface of the coupling 13 through the spline-coupled portion of the rotor shaft 14A and the coupling 13. The flowed-out cooling medium is moved outward by the centrifugal force and the most of the cooling medium reaches a second blade 35 provided to the outer circumferential surface of the rotor 14. The cooling medium having reached the second blade 35 is discharged through a discharge hole 35A provided in the second blade 35 by virtue of the centrifugal force, thereby efficiently cooling the coil end of the coil 52 facing the first housing 11.

On the other hand, the cooling medium supplied to the cooling medium introduction channel 31 and flowed toward the cooling medium branch channel 33 flows out to the upper part of the support 17A. The cooling medium having flowed out spreads around the support 17A and subsequently moved outward by the centrifugal force to reach the first blade 34. The cooling medium having reached the first blade 34 is, as described above, discharged from the discharge hole 34A by the centrifugal force to cool the coil end.

The cooling medium having cooled the coil end drops down through the inside of the first and second housings 11, 16 to be accumulated in the oil reservoir 21, from which the cooling medium is delivered to an oil cooler inlet 23 shown in FIG. 3 through a discharge channel 22, a non-illustrated filter and a non-illustrated pump. The cooling medium having been cooled by the oil cooler is again supplied from the oil cooler outlet 24 to the upper part of the cooling medium introduction channel 31 through a pipe 25.

### [Structure of Stator and Rotor]

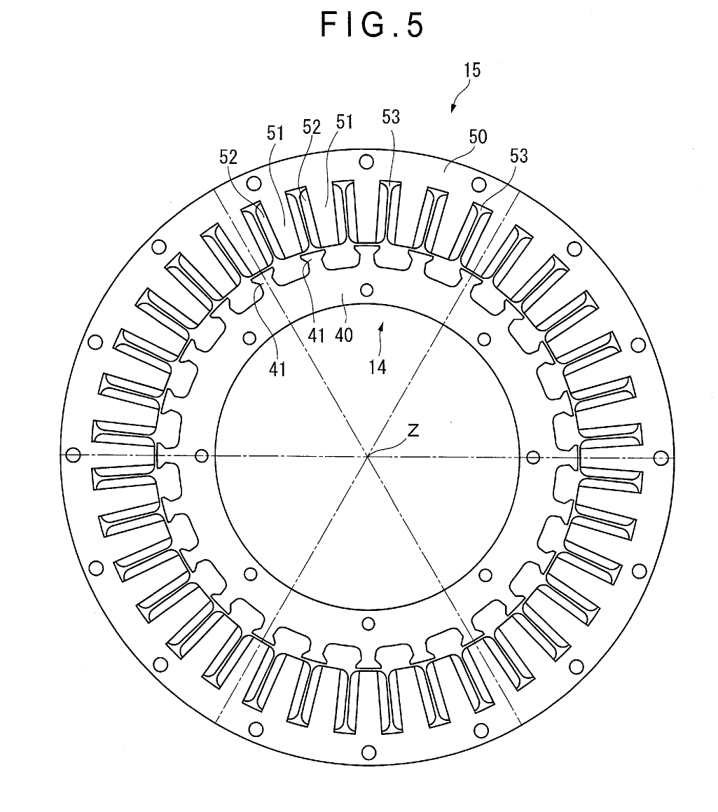

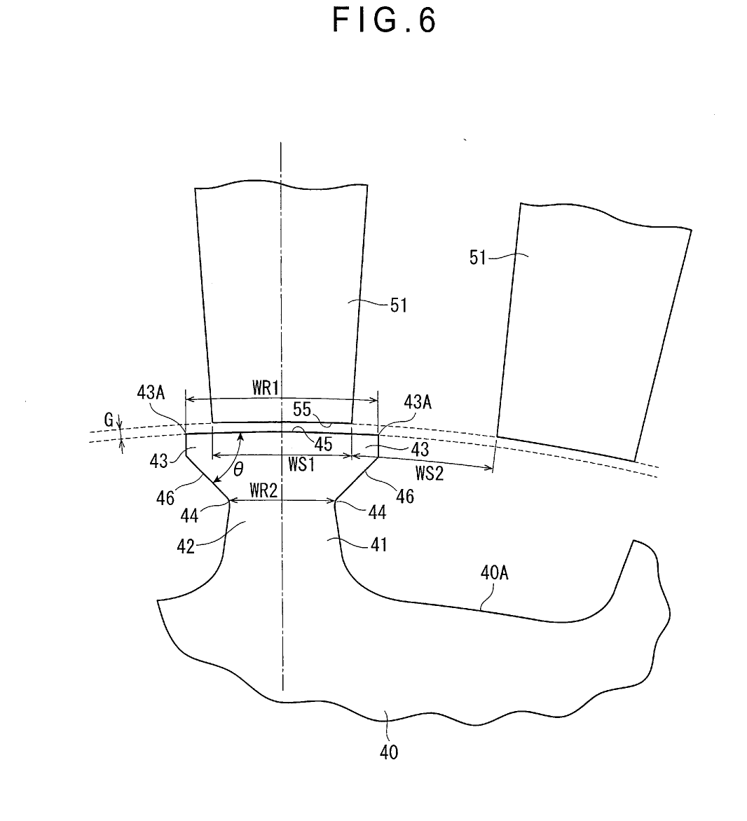

FIG. 5 is a front elevational view showing the rotor 14 and the stator 15 of the power generator motor 10. FIG. 6 is an enlarged illustration of a relevant part of the rotor 14 and the stator 15.

As shown in FIG. 5, the rotor 14 includes the ring-shaped rotor core 40. The rotor core 40 is a component including a plurality of layered electromagnetic steel plates. Each of the electromagnetic steel plates has the same shape. Thus, the cross sections of the rotor core 40 cut along planes orthogonal to the rotation center axis Z of the rotor 14 are the same at any position. The rotor core 40 is provided with a plurality of rotor teeth 41 projecting toward the stator 15. The rotor teeth 41 are equally spaced with each other in the circumferential direction on the rotor core 40 at regular intervals. In this exemplary embodiment, in order to provide twenty-four poles to the rotor 14, the rotor core 40 includes twenty-four rotor teeth 41 in total. Each of the rotor teeth 41 is axis-symmetrically shaped with respect to a centerline extending along a radial direction of the rotor 40.

The stator 15 includes a ring-shaped stator core 50. The stator core 50 is a component including a plurality of layered electromagnetic steel plates. Each of the electromagnetic steel plates has the same shape. Thus, the cross sections of the stator core 50 cut along planes orthogonal to the rotation center axis Z of the rotor 14 are the same at any position. The stator core 50 is provided with a plurality of stator teeth 51 projecting toward the rotor 14. The stator teeth 51 are equally spaced with each other in the circumferential direction on the stator core 50 at regular intervals. The coil 52 is wound around each of the stator teeth 51 in concentrated winding. In this exemplary embodiment, in order to provide thirty-six poles to the stator 15, the stator core 50 includes thirty-six stator teeth 51 in total. A slot 53 is defined by a space between adjacent ones of the stator teeth 51. Each of the stator teeth 51 is also axis-symmetrically shaped with respect to a centerline extending along a radial direction of the stator 50.

As shown in an enlarged manner in FIG. 6, each of the rotor teeth 41 projects from an outer surface 40A of a rotor yoke and includes a convex teeth body 42, and extending portions 43, 43 circumferentially extending from both sides of an end of the teeth body 42. An edge 43A is formed at a circumferential peripheral edge of an end of each of the extending portions 43. The edge 43A moderates the change in the radial force between the rotor teeth 41 and the stator teeth 51, so that the generation of harmonic can be restrained and vibrations and noises can be further reduced. A constricted portion 44 having a circumferential minimum width WR2 smaller than a circumferential width WS1 of an end of each of the stator teeth 51 is provided to an intermediate portion in the projecting direction of each of the rotor teeth 41. The “intermediate portion in the projecting direction” refers to a part between a rise portion with respect to the outer surface 40A of the rotor yoke and a base portion of the circumferentially extending portion 43.

In other words, each of the rotor teeth 41 projects in a tapered manner from the rotor core 40 and enlarges in the circumferential direction from a middle part to an end thereof. The constricted portion 44 is defined at a transition point from the tapered portion to the enlarged portion of the teeth body 42. The extending portion 43 is defined by the circumferentially enlarged portion at the end in the projecting direction. Each of the rotor teeth 41 includes an arc face 45 continuously extending over the end of the teeth body 42 and the extending portion 43.

In other words, the end of each of the stator teeth 51, and the end of each of the rotor teeth 41 adjacently facing the end of each of the stator teeth 51 are both defined as the arc faces 45, 55 extending along the circumferential direction. The edge 43A is the peripheral edge provided to both circumferential sides of the arc face 45 of each of the rotor teeth 41. A gap G created between the arc face 55 at the end of each of the stator teeth 51 and the arc face 45 at the end of each of the rotor teeth 41 is constant over the circumference. Accordingly, the change in the radial force between the rotor teeth 41 and the stator teeth 51 can be further reliably moderated, so that the generation of harmonic can be restrained and vibrations and noises can be further reduced.

A circumferential width WR1 of the end of each of the rotor teeth 41 is more than 1.5 times as large as the circumferential minimum width WR2 of the constricted portion 44. Further, the circumferential minimum width WR2 of the constricted portion 44 is less than 0.75 times as large as the width WS1 of the end of each of the stator teeth 51. The circumferential width WR1 is the best at around 1.25 times as large as the width WS1. An angle θ defined by the arc face 45 of each of the rotor teeth 41 and a slant face 46 extending from the constricted portion 44 to the extending portion 43 is approximately 45 degrees. A ratio (WS1:WS2) of the width WS1 at the end of each of the stator teeth 51 to an opening width WS2 of the slot 53 (FIG. 5) is 4:6.

### [Characteristics and Advantage]

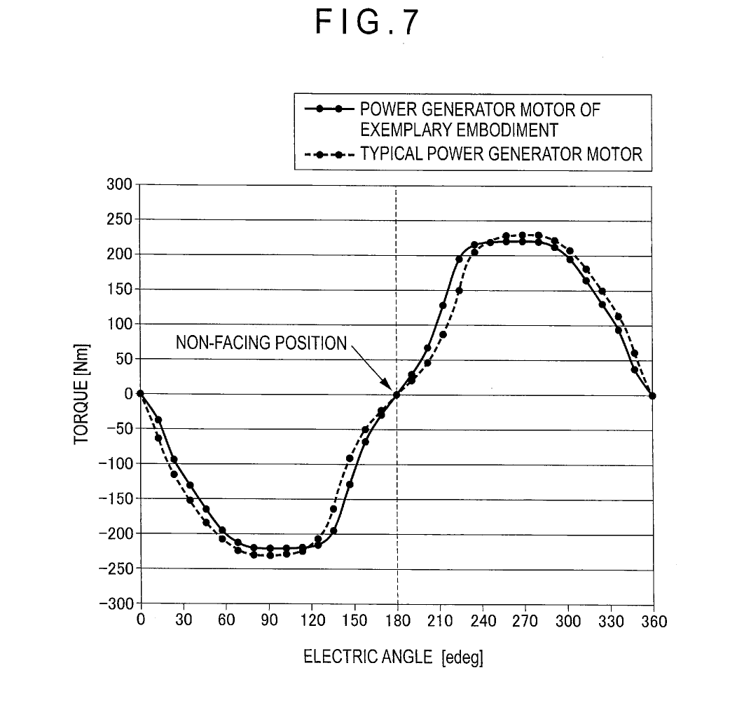

FIG. 7 shows static torque characteristics of the power generator motor 10. The static torque characteristics of the power generator motor 10 of the exemplary embodiment are shown in a solid line, whereas the static torque characteristics of the typical power generator motor of the related art are shown in a dotted line. The static torque characteristics refers to characteristics obtained by measuring a torque required for rotating the rotor 14 in a magnetic field generated when a direct current is fed to the coil 52 for one phase of the stator 15. The abscissa axis in FIG. 7 represents electric angle (edge (degree)), and the ordinate axis represents a torque (Nm).

At the electric angle of 180 degrees, one of the stator teeth 51 is positioned between adjacent pair of the rotor teeth 41 (i.e. at a non-facing position where one of the rotor teeth 41 does not face the one of the stator teeth 51). In the power generator motor 10 of the exemplary embodiment, when the rotor 14 advances from the non-facing position, the edge 43A of the extending portion 43 approaches the stator teeth 51 faster than that of the typical power generator motor, so that the torque begins to be generated at an early stage immediately after starting the advancement, reaches near the peak around 230 degrees and continues to around 280 degrees.

The above characteristics can be attributed to the presence of the extending portion 43 on the rotor teeth 41. Accordingly, since the power generator motor 10 starts generation of a predetermined torque at a position near the non-facing position, a sufficient torque can be obtained without applying the electric current until the rotor teeth 41 face the stator teeth 51, so that the radial force generated between the rotor teeth 41 and the stator teeth 51, and consequent vibrations and noises can be reduced.

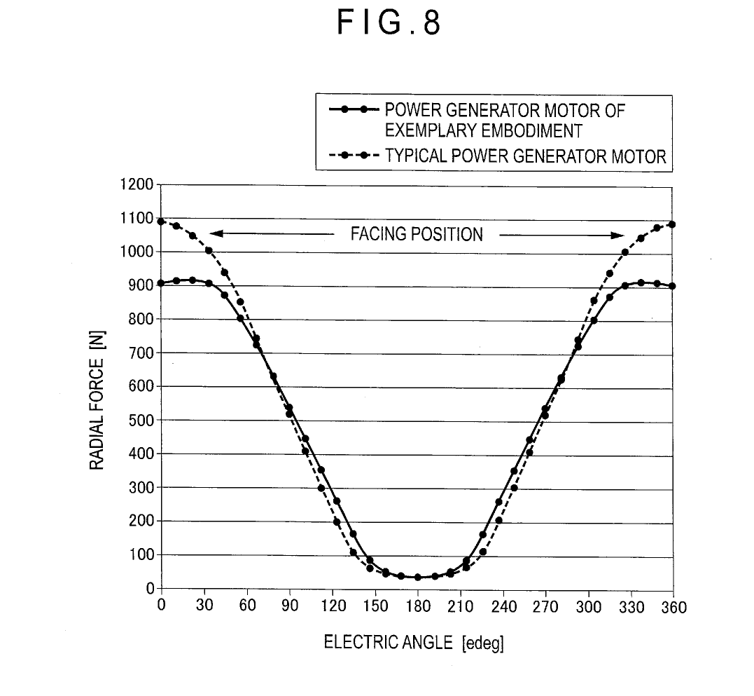

FIG. 8 shows the radial force between the rotor teeth 41 and the stator teeth 51 that changes depending on the electric angle. The radial force of the power generator motor 10 of the exemplary embodiment is shown in a solid line, whereas the radial force of the typical power generator motor of the related art is shown in a dotted line. The radial force is a value obtained based on a magnetic field lines (interlinkage magnetic flux) passing through the rotor teeth 41 and the stator teeth 51 when a direct current is supplied to the coil 52 for one-phase of the stator 15. The abscissa axis in FIG. 8 represents electric angle (edeg(degree)), and the ordinate axis represents the radial force (N).

In the exemplary embodiment, since the constricted portion 44 having the most appropriate minimum width WR2 is provided to each of the rotor teeth 41, a magnetic saturation is caused at the constricted portion 44, thereby restraining the radial force. Consequently, the maximum radial force (the peak of the radial force) becomes flat as shown in FIG. 8, so that the radial force can be reliably reduced as compared with an instance in which the maximum magnetic saturation is difficult to be generated, and thus the noises can be efficiently reduced. Further, since the maximum radial force for the one-phase becomes small, when the power generator motor 10 is actually driven in three phases, the reduction of the radial force between peaks of each phases can be significantly restrained, so that the vibration can be considerably restrained.

Further, as compared with an instance where the extending portion 43 is not provided to each of the rotor teeth 41, the generation of the radial force starts at an earlier stage due to the presence of the extending portion 43, so that the temporal variation in the radial force can be reduced and the harmonic component of the radial force can be restrained. Further, since the edge 43A is provided at the peripheral edge of the extending portion 43, the change in the radial force can be moderated, so that the harmonic can be also reduced for this reason. Accordingly, in conjunction with the effect of the constricted portion 44, the vibrations and noises can be reliably reduced.

Especially, since the relationships between the circumferential width WR1 of the end of each of the rotor teeth 41, the circumferential minimum width WR2 of the constricted portion 44, and the width WS1 of the end of each of the stator teeth 51 are appropriately set, the above advantageous effect can be eminently exhibited.

Incidentally, it should be understood that the scope of the present invention is not limited to the above-described exemplary embodiment(s) but includes modifications and improvements as long as the modifications and improvements are compatible with the invention.

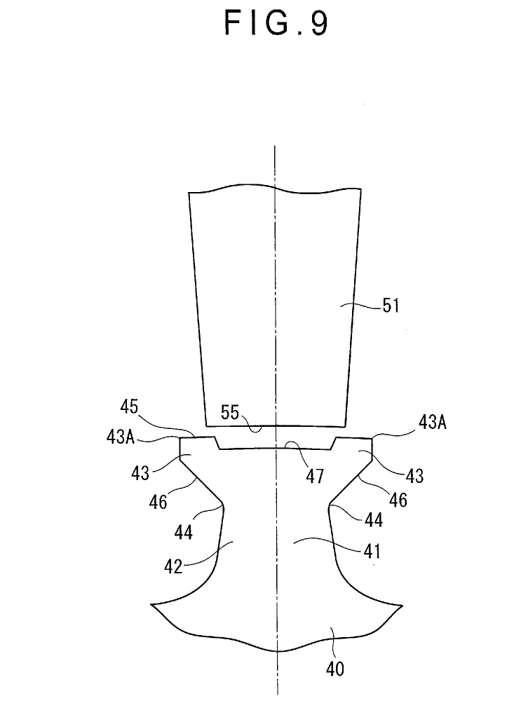

For instance, though the end of each of the rotor teeth 41 is defined as the simple arc face 45, a recess 47 dented with respect to the arc face 45 by a predetermined depth may be provided to the end of each of the rotor teeth 41 as shown in FIG. 9. Since the presence of the recess 47 increases the magnetic resistance, the radial force and, consequently, the vibrations and noises can be further reduced.

The relationships between the widths WR1, WR2, WS1 and WS2 of the rotor teeth 41 and the stator teeth 51 are defined in the above exemplary embodiment. However, even when the widths are defined in a range out of the above relationships, such an arrangement is also within the scope of the present invention as long as being compatible with an object of the invention. Specifically, even when the width WR1 of the end of each of the rotor teeth 41 including the extending portion 43 is smaller than the width WS1 of the end of each of the stator teeth 51, such an arrangement is also within the scope of the invention as long as each of the rotor teeth 41 includes the extending portion 43 provided with the edge 43A and the constricted portion 44 of the invention.

Though the gap G between each of the rotor teeth 41 and each of the stator teeth 51 stays constant over the entire circumference, the size of the gap G may be gradually increased toward both sides in the circumferential direction as disclosed in Patent Literature 1 mentioned in the Background Art section.

Though the constricted portion 44 having the minimum width WR2 of each of the rotor teeth 41 is provided correspondingly to a position of the intersection of the teeth body 42 and the slant face 46 of the extending portion 43, the constricted portion 44 may alternatively be provided at an inner side of the intersection (i.e. near the rotation center axis Z).

### INDUSTRIAL APPLICABILITY

The invention is applicable to a hybrid automobile, electric automobile and electric construction machine as well as a hybrid construction machine.

### EXPLANATION OF CODE(S)

10 . . . power generator motor (rotary electric machine), 14 . . . rotor, 15 . . . stator, 41 . . . rotor teeth, 42 . . . teeth body, 43 . . . extending portion, 43A . . . edge, 44 . . . constricted portion, 45 . . . arc face, 51 . . . stator teeth, 52 . . . coil, G . . . gap, Z . . . rotation center axis, WR2 . . . minimum width.

1. A rotary electric machine comprising:
a ring-shaped stator;
a rotor disposed to an inside of the stator in a rotatable manner;
a plurality of stator teeth provided to the stator equally spaced with each other in a circumferential direction of the stator, the stator teeth projecting toward the rotor and each provided with a coil wound therearound; and
a plurality of rotor teeth provided to the rotor equally spaced with each other in a circumferential direction of the rotor, the rotor teeth projecting toward the stator, wherein
the rotor teeth each comprise a convex teeth body and extending portions extending from both sides of an end of the teeth body in the circumferential direction of the rotor, and
a constricted portion with a circumferential minimum width smaller than a circumferential width of an end of each of the stator teeth is provided to an intermediate portion in a projecting direction of each of the rotor teeth.

2. The rotary electric machine according to claim 1, wherein
an edge is formed at a circumferential peripheral edge of an end of each of the extending portions.

3. The rotary electric machine according to claim 1, wherein
a circumferential width of an end of each of the rotor teeth is more than 1.5 times as large as the circumferential minimum width of the constricted portion.

4. The rotary electric machine according to claim 1, wherein
the circumferential minimum width of the constricted portion is less than 0.75 times as large as the width of the end of each of the stator teeth.

5. The rotary electric machine according to claim 1, wherein
each of the rotor teeth comprises an arc face continuously extending over the end of the teeth body and the extending portion, and
a gap defined between the arc face and an arc face defined at the end of each of the stator teeth is circumferentially constant.

6. A rotary electric machine comprising:
a ring-shaped stator;
a rotor disposed to an inside of the stator in a rotatable manner;
a plurality of stator teeth provided to the stator equally spaced with each other in a circumferential direction, the stator teeth projecting toward the rotor and each provided with a coil wound therearound; and
a plurality of rotor teeth provided to the rotor equally spaced with each other in a circumferential direction, the rotor teeth projecting toward the stator, wherein
the rotor teeth each comprise a convex teeth body, extending portions extending from both sides of an end of the teeth body in the circumferential direction, and an arc face continuously extending over the end of the teeth body and the extending portions,
a gap defined between the arc face and an arc face defined at the end of each of the stator teeth is circumferentially constant,
an edge is formed at a circumferential peripheral edge of an end of each of the extending portions,
a constricted portion with a circumferential minimum width is provided to an intermediate portion in a projecting direction of each of the rotor teeth,
a circumferential width of an end of each of the rotor teeth is more than 1.5 times as large as the circumferential minimum width of the constricted portion, and
the circumferential minimum width of the constricted portion is less than 0.75 times as large as the width of the end of each of the stator teeth.
